(19) United States
(12) Patent Application Publication
(10) Pub. No.: US 2022/0194750 A1
(43) Pub. Date: Jun. 23, 2022

(54) WIND SPEED INDICATOR

(71) Applicant: Delaware Capital Formation, Inc., Wilmington, DE (US)

(72) Inventors: Haroon A. Khan, Tulsa, OK (US); DARREN SCOTT BARNES, Tulsa, OK (US); HARI PRASAD, C V Raman Nagar (IN); MICHAEL JAMES MARTELL, Tulsa, OK (US); DAVID MICHAEL BEREZOWSKI, Broken Arrow, OK (US); ANDREW HARMON, Tulsa, OK (US)

(21) Appl. No.: 17/554,923

(22) Filed: Dec. 17, 2021

Related U.S. Application Data
(60) Provisional application No. 63/126,568, filed on Dec. 17, 2020.

(51) Int. Cl. B66C 13/16; B66C 15/00

(52) U.S. Cl. CPC B66C 13/16; B66C 15/00

(57) ABSTRACT

A solid-state anemometer mounted to an upper location of a load boom and detecting a wind speed reading at the upper location on the load boom. A wireless transmitter communicatively coupled to the solid-state anemometer and obtains the wind speed reading and wirelessly transmits the same to a receiver.

### CROSS-REFERENCE TO RELATED CASES

This application claims the benefit of U.S. provisional patent application Ser. No. 63/126,568, filed on Dec. 17, 2020, and incorporates such provisional application by reference into this disclosure as if fully set out at this point.

### FIELD OF THE INVENTION

This invention relates to wind speed indication devices in general and, more specifically, to wind speed indication devices for use with cranes or lifting machines.

### BACKGROUND OF THE INVENTION

Knowing wind speed is an important aspect of safe operation of cranes and other lifting machines. Prior systems rely on mechanical measurements (e.g., rotating anemometers) that can wear out or become unreliable due to mechanical failure. Transportation or relocation of cranes of other lifting devices can also have deleterious effect on mechanical measurement devices.

What is needed is a system and method for addressing the above and related problems.

### BRIEF DESCRIPTION OF THE DRAWINGS

FIG. 1 is a system diagram of a wireless wind speed indicator according to the present disclosure showing components in anterior perspective view.

FIG. 2 is a system diagram of the wireless wind speed indicator of FIG. 1 showing components in posterior perspective view.

FIG. 3 is a perspective diagram of a wireless wind speed indicator with ATB switch according to the present disclosure.

FIG. 4 is a perspective diagram of a wired wind speed indicator according to aspects of the present disclosure.

FIG. 5 is a side plan view of a crane having a wind speed indicator device installed according to the present disclosure.

FIG. 6 is a display for a wind speed indicator according to aspect of the present disclosure.

FIG. 7 is another display for a wind speed indicator according to aspects of the present disclosure.

### SUMMARY OF THE INVENTION

The invention of the present disclosure, in one aspect thereof, comprises a system for use with a lifting machine having a load boom. The system includes a solid-state anemometer mounted to an upper location on the load boom and detecting a wind speed reading at the upper location on the load boom, and a wireless transmitter communicatively coupled to the solid-state anemometer and obtaining the wind speed reading and wirelessly transmitting the same to a receiver.

In some embodiments, the receiver comprises a wireless receiver outputting the wind speed reading. The system may also include first display obtaining the wind speed reading from the wireless receiver and displaying the wind speed reading. The first display may be inside a cab of the lifting machine. The first display may indicate the wind speed exceeding at least a lower threshold and an upper threshold. The first display may also indicate the wind speed exceeding at least a lower threshold and an upper threshold by illumination of at least two lights of different colors.

The system may include an ATB switch communicatively coupled to the wireless transmitter, the wireless transmitter transmitting data from the ATB switch to the receiver. The ATB switch and the solid-state anemometer may be communicatively coupled to the transmitter via a wired commination link. In some cases, the ATB switch and the solid state anemometer are located at a distal end of the boom from an operator's cab of the lifting machine.

The invention of the present disclosure, in another aspect thereof, comprises a system for use with a vehicle providing an elevation or lifting mechanism including an anemometer affixed to an upper portion of the vehicle and gathering a wind speed reading at the upper portion, a transmitter receiving the wind speed reading from the anemometer and transmitting the wind speed reading, and a receiver reviewing the wind speed reading at a location remote from the transmitter. The anemometer does not utilize moving parts to gather the wind speed reading.

In some embodiments, the anemometer also gathers a wind direction reading without use of moving parts. The anemometer may gather a wind direction reading in three dimensions without the user of moving parts. The anemometer be counterweighted to remain upright upon movement of the upper portion of the vehicle.

The transmitter and receiver may communicate wirelessly or over wireline.

The system may comprise a display that receives the windspeed from the receiver and displays the wind speed. The receiver may be outside a cab of the vehicle and the display is remote from the receiver and inside the cab of the vehicle. The display may be one that receives the windspeed from the receiver and provide a visible warning when the wind speed exceeds a lower threshold and a visible alarm when the wind speed exceeds an upper threshold.

The invention of the present disclosure, in another aspect thereof, comprises a system for use with a vehicle having a boom or a work platform. The system has a solid-state anemometer detecting a wind reading at an upper portion of the vehicle, and a signal converter communicatively coupled to the solid-state anemometer and obtaining the wind reading. The signal converter provides an output signal corresponding to the wind reading that is useable by a display device.

The system may further comprise a display device located inside the vehicle.

### DETAILED DESCRIPTION OF THE PREFERRED EMBODIMENTS

According to the present disclosure, various wind speed measurement systems measure and displays wind speed and wind direction. In some embodiments this is accomplished with no moving parts. These systems may also keep a record of wind speed and direction, alert users of wind speed of more than a specified value, track maximum wind gust, and several other features discussed herein.

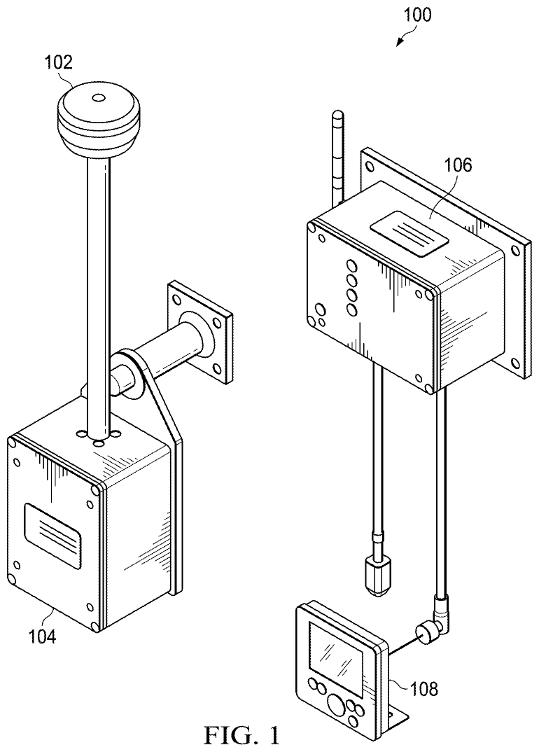

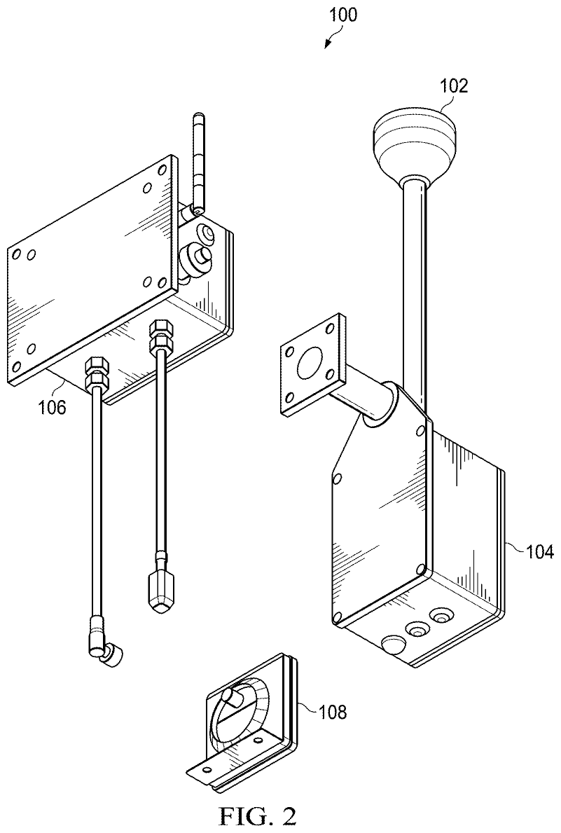

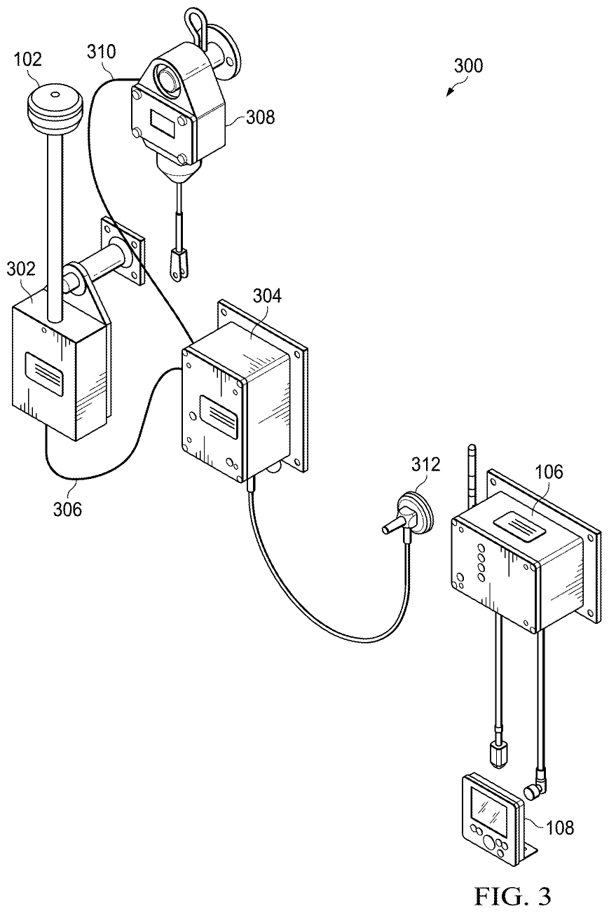

In various embodiments, systems of the present disclosure may be implemented in at least three ways. Without limitation these include a wireless wind speed indication system 100 as in FIG. 1; a wireless wind speed indication system 200 with ATB (anti-two block) switch as in FIG. 2; and a wired wind speed indicator system 300 as in FIG. 3.

Referring specifically now to FIG. 1, a system diagram of the wireless wind speed indication system 100 according to the present disclosure is shown. Here components are in anterior perspective view is shown. FIG. 2 is a system diagram of the wireless wind speed indication system 100 showing components in posterior perspective view. The system 100 as shown in FIGS. 1-2 may comprise the following components: a solid-state anemometer 102 (e.g., an anemometer with no rotating or moving parts required to obtain a wind speed and/or direction); a transmitter 104; a receiver 106; and a display 108.

In some embodiments, the anemometer 102 is an Ultrasonic Wired Standard model available from Calypso Instruments of San Jorge, 1 Zaragoza Spain. In some case the anemometer is a model ULP485, also from Calypso. Other similar components may also be used in this application. For example, an Airmar WS-120WX available from Airmar Technology Corporation, 35 Meadowbrook Drive, Milford, N.H. 03055, USA, may be used.

Anemometers employed pursuant to the present application may be solid state devices. Solid state devices are understood herein to be devices in which no components are required to spin, rotate, or otherwise move in the wind to take a reading. For example, anemometers of the present disclosure do not rely on vanes, blades, propellers, cups, impellers, or the like for operation. The anemometer 102 may have no moving parts at all. Without limitation the anemometer may comprise a hot wire anemometer, a pressure sensing anemometer, a hot ball anemometer, or a non-moving force or torque anemometer.

The anemometer 102 may detect wind speed and direction at its location. In some embodiments, the anemometer 102 of a type that can detect wind direction in three dimensions. The anemometer 102 may have an attached wireless transmitter 104 that transmits data obtained from the anemometer 102 to a wireless receiver 106.

In some embodiments the transmitter 104 comprises an internal PCB (printed circuit board), which contains a wireline (RS-422) receiver as well as a Host Microcontroller (e.g., a Silicon Labs Mighty Gecko EFM32GG12) and microcontroller-based radio module (e.g., Silicon Labs Gecko MGM210P) to transmit 2.4 Ghz wireless signals based on Zigbee wireless protocol. In other embodiments, other controllers and wireless protocols known in the art may be utilized in the transmitter 104.

According to various embodiments, firmware or software may be configured such that wind speed, angle and ATB (anti-two block) switch status is transmitted over the air using Zigbee wireless (or other) protocol. Data logging may include a logs of wind speed, wind angle and ATB state with time stamp recorded over a time period. In some embodiments, data may be retrieved via USB stick or other device. Firmware or software may be written such that the transmitter device goes to deep sleep for a fixed period of time after the wind speed is sampled and transmitted to conserve battery power.

The receiver 106 may be configured to receive data transmitted from the transmitter 104. Accordingly, it may implement the same wireless protocol(s) as the transmitter, as is known in the art. A wired or wireless connection may attach the receiver 106 to a display 108. In some embodiments, multiple displays may be used (for viewing from different locations, for example). The receiver 106 may also provide data output to a computer, controller, or other device having need to access the data received regarding windspeed, direction, and other observed parameters.

In some cases, the display 108 is an input device as well as an output device. Using a user interface that may include, switches, knobs, buttons, and/or a touch screen, a user may be able set some or all of the following parameters (or others): warning speed, alarm speed, localization (units), tracking of maximum wind gust, audible feedback on warning and/or alarm, display direction in degrees, display speed with color coding for nominal, warning, and alarm. As discussed further below, some displays may be adapted to provide simple indications of nominal conditions, warning conditions, and alarm conditions. One of skill in the art will ready appreciate the software or firmware may be configured to accomplish such storage, programing, and recall of parameter, as well as providing nominal, warning, and alarm conditions. The present disclosure is not limited to a particular programming language or particular hardware (silicon) to provide the described systems and methods.

Referring now to FIG. 3, a perspective diagram of a wireless wind speed indication system 300 is shown. The system 300 utilizes the solid-state anemometer 102 with a counterweight 302. The anemometer provides data to a separate wireless transmitter 304 via a wired connection 306. The system 300 also incorporates an ATB switch 308 that also feeds data into the wireless transmitter 304 via a wired connection 310. The wireless transmitter 304 may have an attached external antenna 312 used for wirelessly communicating data from the anemometer 102 and ATB switch 308 to the wireless receiver 106.

It should be understood that the system 300 of FIG. 3 may share many or all functions as that of FIGS. 1-2, plus incorporating ATB switch data. ATB switch data may be fed to the from the receiver 106 to the display 108 or to other control devices making use of such data. The anemometer 102 and the ATB switch 308 may be located physically close together on a crane of lifting device (as described further below) such that having both devices wirelessly communicate via the single transmitter 304 has advantages.

According to various embodiments, a PCB associated with the transmitter 304 and/or receiver 106 may comprise a multi-processor system that enables sending/receipt of J1939 CAN data, receipt of RS422 anemometer data in NMEA0183 protocol and wireless bi-directional Zigbee data for exchange of anemometer and ATB data, and for control of system state. In other embodiments, other data protocols (wireless and wired) as are known on the art may be utilized. The firmware and/or software may be configured for instantaneous detection and transmission of ATB switch state change.

The display 108 may provide similar functionality in the system 300 as with the system 100. However, ATB data is available in the system 300 as shown. It should be understood here too that the system 300 is described in terms of hardware and information that can be provided using the same. However, the system 300 may be subject to implementation with a variety of software, firmware, and logic components by one of skill in the art.

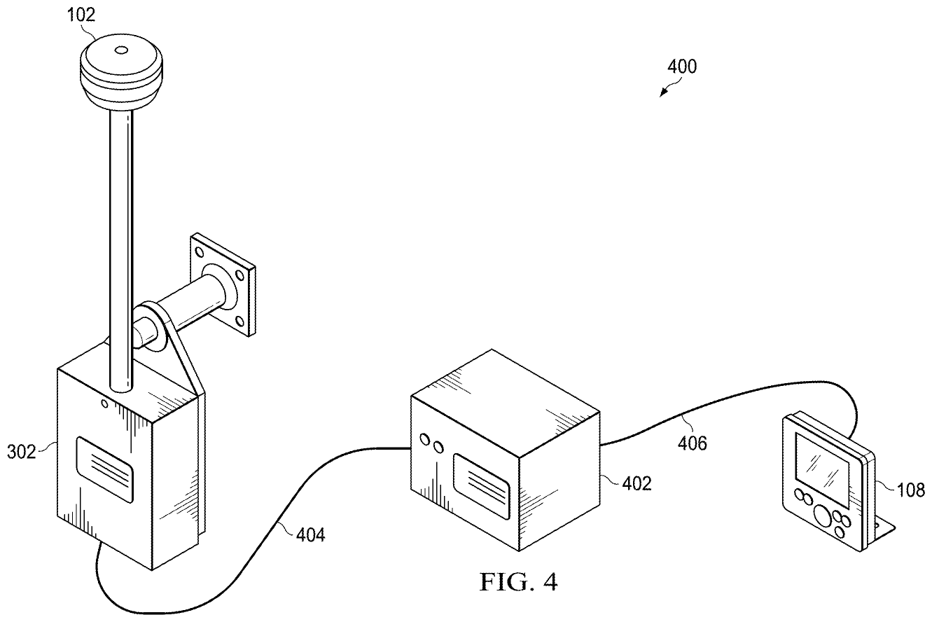

Referring now to FIG. 4 a perspective diagram of a wired wind speed indicator system 400 according to aspects of the present disclosure. The system 400 of FIG. 4 may share some components and functionality with the systems described above, but may rely on wired or wireline data transmission rather than wireless. According to various embodiments, the system 400 of FIG. 4 may include the anemometer 102 with counterweight 302. The counterweight 302 and anemometer 102 may be mounted together on a rotating mount such that the anemometer 102 to remains elevated or upright for optimal wind reading. In the illustrated embodiment 100 of FIGS. 1-2, the transmitter 104 serves a similar levelling/elevating function for the anemometer as the counterweight 302.

The anemometer communicates with a signal converter 402 via wireline connection 404. A further wireline connection 406 connects the display 108 to the signal converter 402. In some embodiments, the signal converter may comprise an 0183 Gateway available from Yacht Devices, Pacific Business Centre, #101-1001 W. Broadway, Suite 381, Vancouver, BC V6H 4E4, Canada. The 0183 Gateway enables signal conversion for NMEA0183 equipment to an NMEA 2000 gateway. Other signal conversion devices as needed and known in the art may also be utilized in various embodiments.

In the system 400, wind speed and other data may be obtained utilizing the anemometer 102 and passed via connection 404 to the signal converter 402 where is converted to a form for use by the display 108. Data may be passed to multiple display and/or to other devices as well (e.g., to control computer and the like).

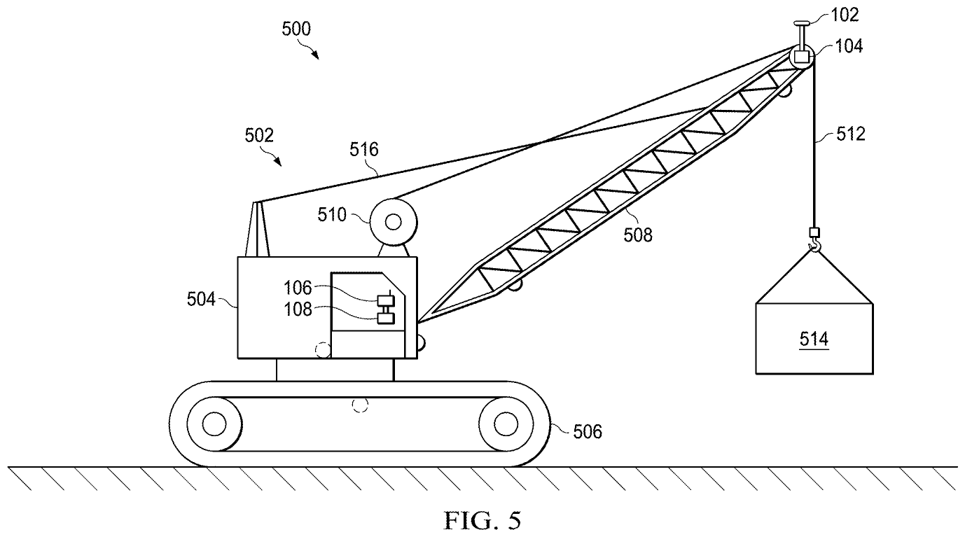

Referring now to FIG. 5, a side plan view of a crane system 502 having a wind speed indicator device installed according to the present disclosure is shown. It is known that cranes and other lifting devices may rely on windspeed data to be operated safely. For instance, in high winds, particular loads may be unsafe to move, or unsafe to move above a certain height, etc.

The system 500 may include a crane 502. A tracked crane 500 is shown but, as explained below, systems of the present disclosure are adaptable for use with a wide variety of lifting devices, personnel lifting devices, and/or towing devices. Here the crane 500 includes a cab 504 that may rotate with respect to a tracked carriage 506 providing general mobility for the crane 502. The cab 504 provides a safe location for the operator and also may be the location to which a boom 508 attaches at a proximal end. A winch 510 may pay out and reel in a winch rope 512 (a cable in most cases) that is strung from the winch 510 to a distal portion of the boom 508 for raising and lowering a load 514. As is known in the art, a guy line 516 (or multiple guy lines) may be used to raise and lower the boom 508 itself. A simple boom 508 is shown for illustrating purposes but systems and methods of the present disclosure are adaptable for use with compound booms including extendible jibs and other implements.

The anemometer 102 is shown mounted to the highest point of the boom 508. From this location may provide the most useful wind speed and direction indication for purposes of assessing safety of operation based on use of charts, control computers, or other methods as are known in the art. In other embodiments, mounting to an upper portion of the crane 502 or boom 508 may provide sufficient data. An upper portion would be considered a portion of the crane 502 or boom 508 that is higher than the load 514 is expected to me lifted or moved. In the event the vehicle utilizing the system (e.g., 100, 300, 400) does not lift or move loads per se, but rather personnel on a lift platform, the upper portion would be a location at least as high as the work platform. The anemometer 102 may be mounted to a location other than a highest location on the boom 508, or an upper or distal portion of the boom where wind readings are needed or desired from such other locations.

The anemometer 102 wireless transmits the detected windspeed and direction to wherever the receiver 106 is located. In the illustrated embodiment, the receiver 106 is located inside the cab 504 and feeds information to the display 108. The receivers might also be located outside the cab 504 for better reception/transmission. In other embodiments, there are multiple receivers and/or multiple displays and/or connections to control computers or other devices utilizing or recording wind speed and direction data from the anemometer 102.

It will be appreciated that a system such as the system 300 can readily be deployed with the crane 502 or other devices. In this case the anemometer 102 would be installed at a similar location as shown in FIG. 5, as the ATB switch 304 would normally be at or near the distal end of the boom 508. The anemometer 102 and ATB switch 304 would then be wired to the transmitter 304 and data from both transmitted to the receiver 106. Similarly, a wired system such as system 400 could be installed by running the necessary wires down the boom and to the signal converter 402 and/or display 108.

The crane 502 is exemplary only, and one of skill in the art will appreciate that the systems and methods of the present disclosure may be adaptable for use with devices such as, without limitation: lifting device including cranes, telehandlers, boom trucks, utility trucks, rough terrain cranes, all terrain cranes, service cranes, crawler cranes, carrydeck cranes, lattice boom cranes, tower cranes, and truck mounted cranes. Devices such as these utilize a boom for lifting loads. For purposes of the present disclosure, unless otherwise specified, and or all of the above-mentioned devices or any devices that utilizes a boom to move a load may be referred to as a crane or a lifting device. In other cases, systems of the present disclosure may find use in or on, without limitation, bucket trucks, mobile elevating work platforms (MEWPs), boom lifts, scissor lifts, vertical lifts, vehicle-mounted elevating and rotating aerial devices, vehicle-mounted elevating and rotating work platforms. Devices such as these may not necessarily move particularly heavy loads (although they may) but nevertheless have an elevating work platform that may be used by an individual and may have need to take wind conditions into account. Devices such as these may be referred to as personnel lifting devices. Finally, in some situations, tow trucks or other towing devices may have need to measure wind speed for certain operations to be performed safely. These may be referred to more generally as towing devices and may include, for example, tow trucks, rotators, rollbacks, recovery vehicles, light duty wreckers, and heavy duty wreckers.

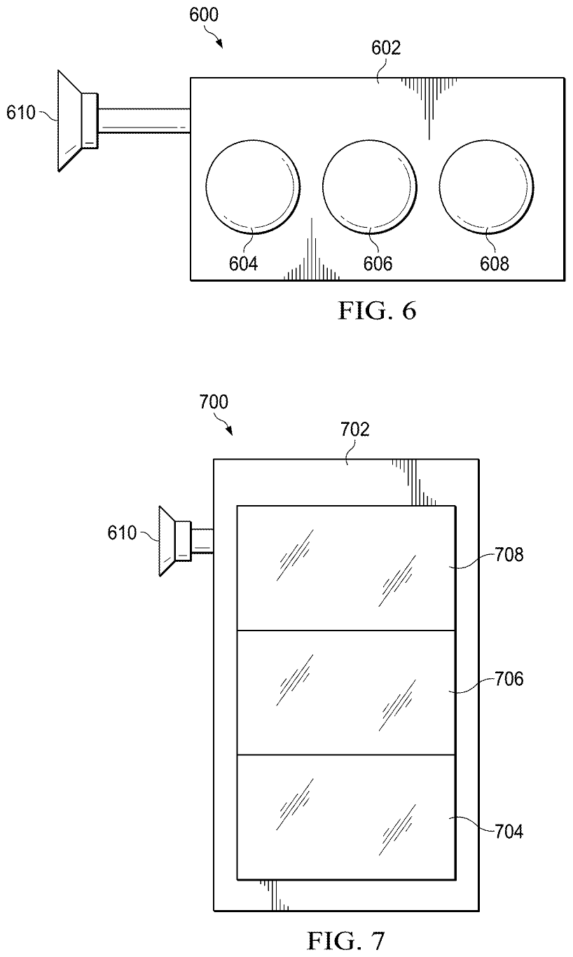

Referring now to FIG. 6 a display 600 for a wind speed indication system according to aspect of the present disclosure is shown. The display 600 could be used instead of or in addition to the display 108 with any of the systems or methods of the present disclosure. Here a simple panel 602 is provided with an array of lights or light emitting diodes (LEDs). These may be, for example, a green light 604, a yellow light 606, and a red light 608. The green light may be illuminated when the detected wind is below lower threshold. If the lower threshold is exceeded, the yellow light 606 may illuminate. The red light 608 may be illuminated when the wind speed exceeds and upper threshold. The thresholds may be predetermined by programming (in software or firmware) and/or by user selection. In some embodiments, the display 600 is implanted in software for display on a general-purpose display. In other cases, it may be an auxiliary display or a second or other display provided at an alternate location for viewing by someone other than the operator, for example.

Audible alarms such as beepers, buzzers, or horns may also be provided. Here this is represented by alarm speaker 610 (which may be included with any embodiment according to the present disclosure). In some embodiments, the volume or sound made by the audible alarm may differ according to wind speed, wind direction, and/or which of the green light 604, yellow light 606, and/or red lights 608 are illuminated.

Referring now to FIG. 7, another display 700 for a wind speed indicator according to aspects of the present disclosure is shown. The display 700 may be part of a general-purpose display screen or may be dedicated, auxiliary, or second or other display as with the display 600. The display 700 comprises a panel 702 with a bar graph comprising multiple segments 704, 706, 708. These may correspond to green, yellow, and red indicators respectively. Within each segment the measured value of wind speed may be further indicated (e.g., such that only part of segment 704, 706, 708 illuminates, and does so progressively to indicate how near the threshold the detected wind speed is). Again, changes between green and yellow may indicate a lower, or caution/warning threshold, and changes between yellow and red may indicate an upper or alarm threshold. These may be predetermined by programming (in software or firmware) or my user selection.

Audible 610 may also be included for use with the display 700. Again, the volume or sound made by the audible alarm 610 may differ according to wind speed, wind direction, and/or which of the segments 704, 706, 708, or portions thereof are illuminated.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for use with a lifting machine having a load boom, the system comprising:
a solid-state anemometer mounted to an upper location on the load boom and detecting a wind speed reading at the upper location on the load boom; and
a wireless transmitter communicatively coupled to the solid-state anemometer and obtaining the wind speed reading and wirelessly transmitting the same to a receiver.

2. The system of claim 1, wherein the receiver comprises a wireless receiver outputting the wind speed reading.

3. The system of claim 4, further comprising a first display obtaining the wind speed reading from the wireless receiver and displaying the wind speed reading.

4. The system of claim 3, wherein the first display is inside a cab of the lifting machine.

5. The system of claim 4, wherein the first display indicates the wind speed exceeding at least a lower threshold and an upper threshold.

6. The system of claim 5, wherein the first display indicates the wind speed exceeding at least a lower threshold and an upper threshold by illumination of at least two lights of different colors.

7. The system of claim 3, further comprising an ATB switch communicatively coupled to the wireless transmitter, the wireless transmitter transmitting data from the ATB switch to the receiver.

8. The system of claim 7, wherein the ATB switch and the solid-state anemometer are communicatively coupled to the transmitter via a wired commination link.

9. The system of claim 8, wherein the ATB switch and the solid state anemometer are located at a distal end of the boom from an operator's cab of the lifting machine.

10. A system for use with a vehicle providing an elevation or lifting mechanism comprising:
an anemometer affixed to an upper portion of the vehicle and gathering a wind speed reading at the upper portion;
a transmitter receiving the wind speed reading from the anemometer and transmitting the wind speed reading; and
a receiver reviewing the wind speed reading at a location remote from the transmitter;
wherein the anemometer does not utilize moving parts to gather the wind speed reading.

11. The system of claim 10, wherein the anemometer gathers a wind direction reading without use of moving parts.

12. The system of claim 11, wherein the anemometer gathers a wind direction reading in three dimensions without the user of moving parts.

13. The system of claim 12, wherein the anemometer is counterweighted to remain upright upon movement of the upper portion of the vehicle.

14. The system of claim 10, wherein the transmitter and receiver communicate wirelessly.

15. The system of claim 10, wherein the transmitter and receiver communicate over wireline.

16. The system of claim 10 further comprising a display that receives the windspeed from the receiver and displays the wind speed.

17. The system of claim 16, wherein the receiver is outside a cab of the vehicle and the display is remote from the receiver and inside the cab of the vehicle.

18. The system of claim 17, wherein the display is visible outside a cab of the vehicle.

19. The system of claim 10, further comprising a display that receives the windspeed from the receiver provides a visible warning when the wind speed exceeds a lower threshold and provides a visible alarm when the wind speed exceeds an upper threshold.

20. The system of claim 10, further comprising an audible alarm that activates according to the windspeed reading received by the receiver.

21. A system comprising for use with a vehicle having a boom or a work platform comprising:
a solid-state anemometer detecting a wind reading at an upper portion of the vehicle; and
a signal converter communicatively coupled to the solid-state anemometer and obtaining the wind reading;
wherein the signal converter provides an output signal corresponding to the wind reading that is useable by a display device.

22. The system of claim 20, further comprising a display device located inside the vehicle.
